(19) United States
(12) Patent Application Publication
(10) Pub. No.: US 2022/0211212 A1
(43) Pub. Date: Jul. 7, 2022

(54) ROASTING GRILL WITH METAL BALL

(71) Applicant: Chaehwan LEE, Daegu (KR)

(72) Inventor: Chaehwan LEE, Daegu (KR)

(21) Appl. No.: 17/535,185

(22) Filed: Nov. 24, 2021

(30) Foreign Application Priority Data
Jan. 6, 2021 (KR) 10-2021-0001276

(51) Int. Cl. A47J 37/04; A47J 37/07

(52) U.S. Cl. CPC A47J 37/049; A47J 37/07

(57) ABSTRACT

The present disclosure relates to a roasting grill with metal balls. The roasting grill includes: a base part provided in a circular or polygonal frame shape having a predetermined height and configured to be seated on a table; a heating part having clogged portions and through hole portions, which are alternately provided at predetermined intervals in the central portion of the base part, the heating part being configured such that multiple metal balls are seated thereon so that food is placed on the metal balls; and the multiple metal balls arranged and seated between the clogged portions and through hole portions on the heating part so that food is placed and grilled thereon. The metal balls are configured in a spherical shape so that the metal balls are rotatable in any direction, whereby it is possible to use the roasting grill without frequent replacement.

### CROSS-REFERENCE TO RELATED APPLICATION

This application claims the benefit of Korean Patent Application No. 10-2021-0001276, filed on Jan. 6, 2021, in the Korean Intellectual Property Office, the disclosure of which is incorporated herein in its entirety by reference.

### BACKGROUND OF THE INVENTION

### 1. Field of the Invention

The present disclosure relates to a roasting grill with metal balls (which may be simply referred to as a “roasting grill” for convenience of description), and more particularly, to a roasting grill, in which metal balls are mounted in a heating portion for cooking food on a roasting grill used for cooking grilled food so that the metal balls are rotatable in any direction, whereby the roasting grill can be used without frequent replacement.

### 2. Description of the Prior Art

A roasting grill used for cooking grilled food such as meat is a cooking tool used for grilling food using heat transmitted from a heat source such as charcoal fire.

Commonly used roasting grills for grilling are classified into a plate-type roasting grill and a gridiron-type roasting grill. A plate-type roasting grill is made in the form in which a number of holes are formed in a circular or quadrilateral metal plate having a convexly curved central portion so as to transfer heat from a heat source located therebeneath and to discharge oil or the like.

A gridiron-shaped roasting grill is made in the form of a grill by weaving fine metal wires in a mesh form on a circular or quadrilateral metal frame or by arranging multiple metal bars on a circular or quadrilateral metal frame.

As an example of a conventionally known roasting grill, Korean Registered Utility Model No. 20-0185532 discloses a roasting grill that includes: a body made of a metal material and having a portion which is curved convexly towards the center thereof and is configured such that meat is placed thereon; multiple oil discharge holes formed around the peripheral edge of the body at a predetermined interval; and multiple valleys formed on the surface of the body inside the oil discharge holes. The roasting grill further includes a streamlined curved portion provided between every two oil discharge holes, wherein the streamlined curved portion is the highest at the middle portion thereof and is gradually lowered towards the circumferential peripheral portion and the central peripheral portion with reference to the highest middle portion.

As another example, Korean Registered Utility Model No. 20-0295935 discloses a charcoal grill for grilling meat by being installed on a brazier with an oil sump arranged at the peripheral edge thereof. The charcoal grill includes: a dome-shaped body including a concave groove having a predetermined inner diameter and formed in the central portion thereof and an oil outlet perforated at the edge thereof; multiple slits that are perforated in the radial direction of the body so that the fire energy of the brazier smoothly communicates therebetween; an oil guide formed to protrude along the periphery of the slits.

As still another example, Korean Registered Utility Model No. 20-0277434 discloses a stainless steel grill having a copper-coated surface that is formed on the surface of the stainless steel grill so as to facilitate cleaning of residues that have burnt and adhered to the surface of the grill.

### PRIOR ART DOCUMENT

### Patent Document

(Patent Document 0001) Korean Registered Utility Model No. 20-0185532 (Jun. 15, 2000)

(Patent Document 0002) Korean Registered Utility Model No. 20-0295935 (Nov. 22, 2002)

(Patent Document 0003) Korean Registered Utility Model No. 20-0277434 (Jun. 3, 2002)

(Patent Document 0004) Korean Registered Utility Model No. 20-0421281 (Jul. 10, 2002)

### SUMMARY OF THE INVENTION

Most roasting grills to which the prior arts as above are applied are made of a metal material that is resistant to heat, and are not easily burned or damaged even when directly exposed to a high-temperature heat source such as charcoal fire. However, when the food on a roasting grill is grilled for more than an appropriate time, a burnt portion will adhere to the roasting grill together with oil.

When food adheres to the roasting grill and is burnt, the flavor of the food is deteriorated, the roasting grill is seriously contaminated, and harmful substances are generated. Therefore, it is necessary to frequently replace roasting grills. In fact, it has been found that, when cooking grilled food such as meat during meals, roasting grills are replaced on average three times or more on one table, which causes inconvenience such as a temporary interruption of the meals.

In addition, when roasting grills are frequently replaced as in the prior art, the consumption of roasting grills increases, and thus, a large amount of time and money are required for processing. In particular, since it is difficult to wash residues that have burnt and adhered to roasting grills by hand, most of the roasting grills are processed using a roasting grill washing device or are entrusted to a separate cleaning company for processing.

Meanwhile, in another prior art, roasting grills are coated in order to solve the problems described above, thereby achieving the effect of reducing food adhesion. However there is a problem in that the possibility of an increase in manufacturing cost or the possibility of the peeling-off of coating in the process of cleaning the roasting grills cannot be excluded.

Accordingly, the present disclosure was made to solve the problems of the prior arts described above.

In view of the foregoing, an aspect of the present disclosure provides a roasting grill is configured to be installed on the upper portion of a brazier accommodating a heat source to cook food for grilling. The roasting grill includes: a base part 110 provided in a circular or polygonal frame shape having a predetermined height and configured to be seated on a table; a heating part 120 having clogged portions and through hole portions, which are alternately provided at predetermined intervals in the central portion of the base part 110, the heating part 120 being configured such that multiple metal balls 130 are seated thereon so that food is placed on the metal balls 130; and the multiple metal balls 130 arranged and seated between the clogged portions and through hole portions on the heating part 120 so that food is placed and grilled thereon.

The metal balls 130 are made of a stainless steel, copper, or cast iron material and are configured in a spherical shape having a diameter of 20 to 50 mm so that the metal balls are rotatable in any direction, whereby it is possible to use the roasting grill without frequent replacement.

The present disclosure provides a roasting grill having metal balls mounted on a heating part for cooking food on the roasting grill used for cooking grilled food.

In particular, according to the present disclosure, even if food adheres to the metal balls, it is possible to roll the metal balls in any direction and to grill the food on the unused sides of the metal balls. Therefore, once the roasting grill is set, it is possible to use the roasting grill, without frequent replacement.

Therefore, according to the present disclosure, it is possible to minimize the consumption of time, cost, and manpower due to frequent replacement of roasting grills when using conventional roasting grills. Further, if necessary, the metal balls may be replaced unit by unit, which makes it possible to use the roasting grill more economically and efficiently.

In addition, the metal balls according to the present disclosure are made of stainless steel or copper material that is harmless to the human body so as to be hygienic and do not require coating so as to enable semi-permanent use. Further, the metal balls have the effect of providing the unique appearance thereof and differentiated functionality.

In addition, the roasting grill according to the present disclosure has an advantage in that it is possible to more easily clean the roasting grill by friction only with the simple operation of rolling the metal balls during cleaning, thereby making the cleaning operation efficient.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a perspective view of a roasting grill according to the present disclosure;

FIG. 2 is an exploded perspective view of the roasting grill according to the present disclosure;

FIG. 3 is a perspective view of a base part of the roasting grill according to the present disclosure;

FIG. 4 is a plan view of the base part of the roasting grill according to the present disclosure;

FIG. 5 is a cross-sectional view taken along line A-A in FIG. 4;

FIG. 6 is a cross-sectional view taken along line B-B in FIG. 4;

FIG. 7 is a cross-sectional view illustrating the state in which the metal balls are seated in the base part illustrated in FIG. 5;

FIG. 8 is a perspective view of a roasting grill according to another embodiment of the present disclosure; and

FIG. 9 is a perspective view of a roasting grill according to still another embodiment of the present disclosure.

### DETAILED DESCRIPTION OF THE EXEMPLARY EMBODIMENTS

Hereinafter, the configurations and operations of roasting grills with metal balls according to embodiments of the present disclosure will be described in detail with reference to the accompanying drawings. In the following description, detailed descriptions of parts that can be easily implemented by those skilled in the art may be omitted.

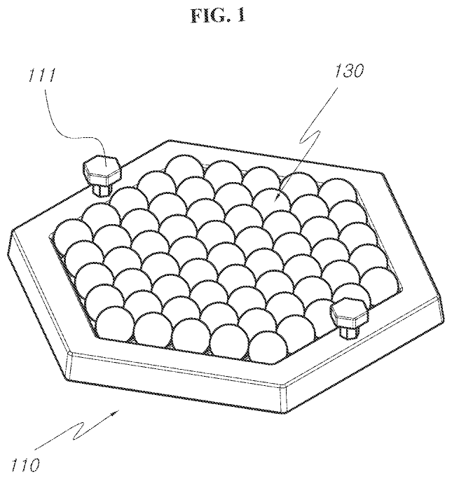

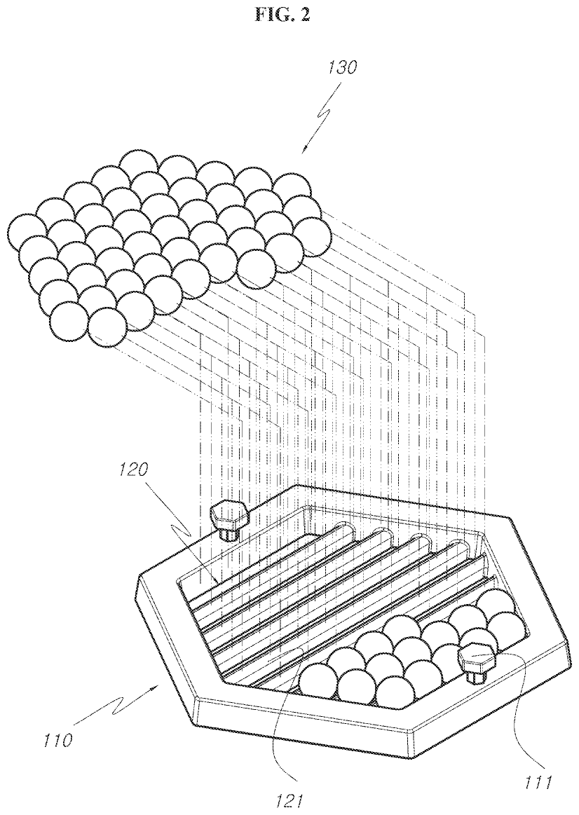

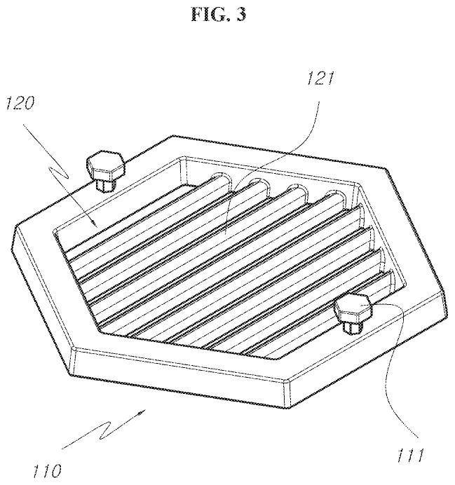

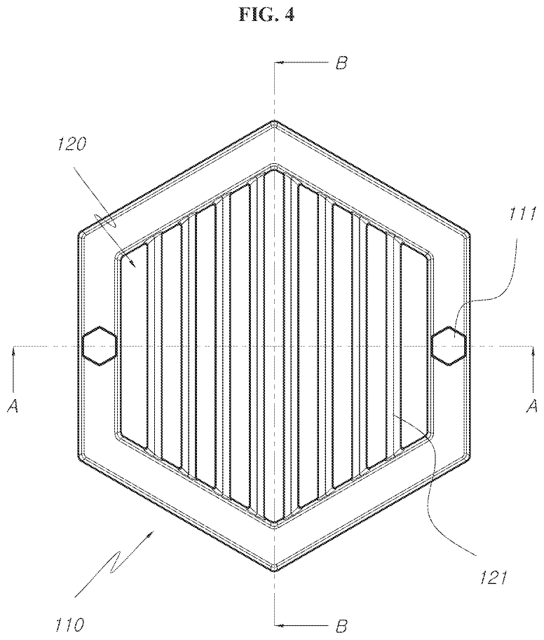

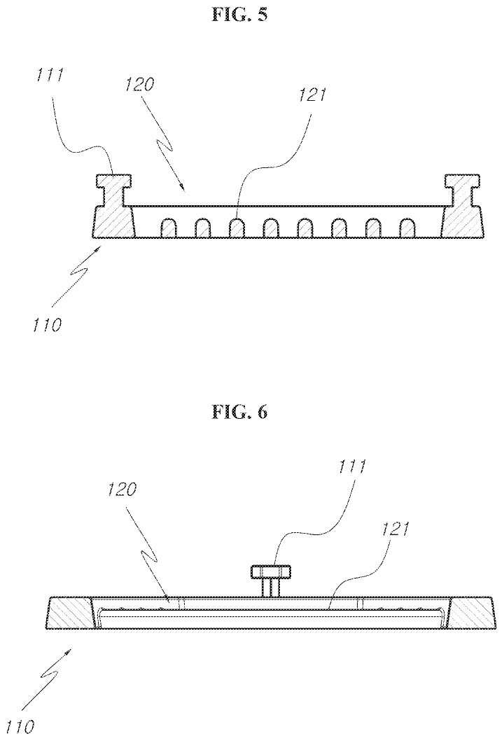

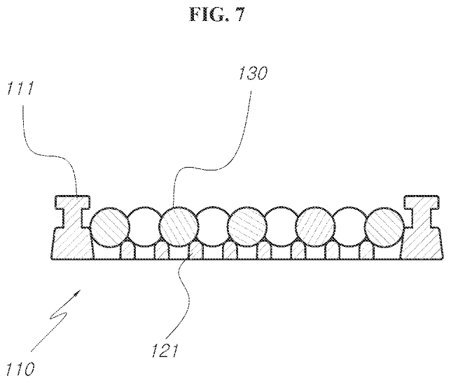

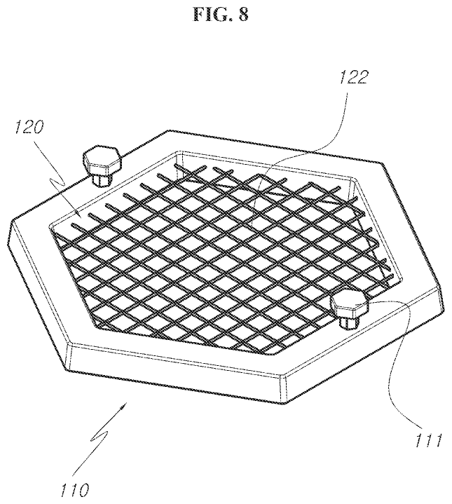

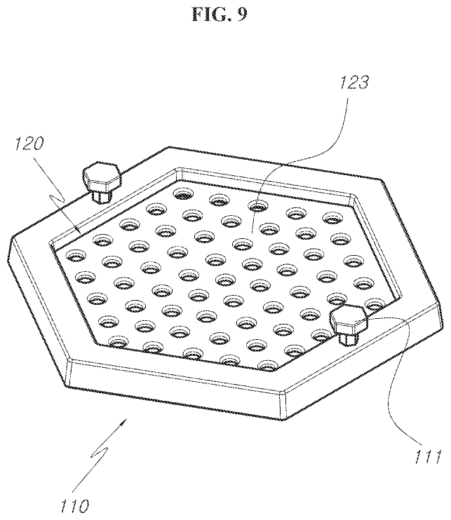

FIG. 1 is a perspective view of a roasting grill according to the present disclosure, FIG. 2 is an exploded perspective view of the roasting grill according to the present disclosure, FIG. 3 is a perspective view of a base part of the roasting grill according to the present disclosure, and FIG. 4 is a plan view of the base part of the roasting grill according to the present disclosure. FIG. 5 is a cross-sectional view taken along line A-A in FIG. 4, FIG. 6 is a cross-sectional view taken along line B-B in FIG. 4, and FIG. 7 is a cross-sectional view illustrating the state in which the metal balls are seated in the base part illustrated in FIG. 5. FIG. 8 is a perspective view of a roasting grill according to another embodiment of the present disclosure, and FIG. 9 is a perspective view of a roasting grill according to still another embodiment of the present disclosure.

It is noted that the roasting grill to which the technique of the present disclosure is applied is configured such that food is grilled by mounting metal balls on a heating part for cooking the food on the roasting grill used for cooking of grilled food such as charcoal grilling, whereby the roasting grill can be used while rotating metal balls in any direction.

For this purpose, the roasting grill according to the present disclosure is configured to be installed on the upper portion of a brazier that accommodates a heat source and to cook food to be grilled by including a predetermined guide at the peripheral portion thereof, and generally includes a base part 110, a heating part 120, and metal balls 130.

The base part 110 is provided in a circular or polygonal frame shape having a predetermined height so as to be seated on a table.

The base part 110 is provided in an endless frame shape such that the heating part 120, which will be described later, is located on the upper side of a brazier, and the central portion thereof has through holes and is made of a thermally conductive metal material.

A predetermined guide may be provided on the outside of the base part 110, and the shape of the base part 110 may be variously applied depending on the installation environment thereof.

The height of the base part 110 has a range in which the metal balls 130 are capable of being stably seated on the heating part 120 to be described later. For example, the level in which the height of the base part 110 is located is preferably higher than the centers of the metal balls 130 in the state in which the metal balls 130 are seated on the heating part 120.

The base part 110 has a predetermined taper from the bottom surface towards the top surface such that the center of gravity is stably maintained on the table during use.

The base part 110 is provided with predetermined handles 111 on opposite sides thereof. The handles 111 are provided to be capable of moving the base part 110, the heating part 120 provided on the base part 110, and the metal balls 130 in unison, and various shapes, such as a protruding shape as in the embodiment of the present disclosure or a ring shape, may be applied as the shape of the handles 111.

The heating part 120 includes clogged portions and through hole portions, which are alternately provided at predetermined intervals in the central portion of the base part 110, and multiple metal balls 130 that are seated on the heating part 120 such that food is placed on the metal balls 130.

The heating part 120 is a region that is provided directly above the brazier so as to heat and cook food, and is integrally provided in the central portion of the base unit 110 using the same material as the base part 110.

The heating part 120 is formed in the form in which multiple clogged portions and through hole portions are disposed on a plane.

The clogged portions have end portions integrally connected to the inner circumferential surface of the base part 110, and provided such that the metal balls 130, which will be described later, are seated thereon.

The through hole portions are provided to transfer heat from the lower brazier to the food between the multiple clogged portions.

Meanwhile, depending on the shape or arrangement state of the clogged portions, the heating part 120 is configured as a seating bar 121 type as illustrated in FIG. 3, a seating mesh 122 type as illustrated in FIG. 8, or a perforated seating plate 123 type as illustrated in FIG. 9.

The seating bar 121 type heating part 120 includes clogged portions provided by arranging multiple seating bars 121 parallel to each other at a height lower than the upper end of the base part 110.

The seating bars 121 are formed in a straight bar shape and are provided to connect both ends to the inner circumferential surface of the center of the base part 110. The multiple seating bars 121 are arranged parallel to each other in one direction.

The height of the bottom surfaces of the seating bars 121 correspond to the bottom surface of the base part 110, but the height of the top surfaces of the seating bars 121 is located lower than the top surfaces of the base part 110 in the rage in which the metal balls 130 seated on the seating bars 121 are capable of being stably seated.

The interval between the through-hole portions between the multiple seating bars 121 are shorter than the diameter of the metal balls 130.

Since the multiple seating bars 121 are configured such that the spherical metal balls 130, which will be described later, are seated therebetween, the interval between the seating bars 121 is shorter than the diameter of the steel balls 130.

The width of the seating bars 121 is preferably determined at a level at which the metal balls 130 are maintained as close as possible without interfering with each other in the state in which the metal balls 130 are seated between the multiple seating bars 121.

Each of the seating bars 121 has a round top surface and is configured to make the metal balls 130 rollable.

The metal balls 130 seated between the multiple seating bars 121 according to the present disclosure operate in a manner that changes the surfaces that are in contact with food by rolling the metal balls 130 in any direction, instead of replacing roasting grills as in the prior art. Therefore, the seating bars 121 are provided in a round shape in order to prevent the spherical surfaces of the metal balls 130 from being damaged or separated by rubbing against the edges of the top surfaces of the seating bars 121 or to prevent the rollable performance of the seating bars 121 from being inhibited.

Meanwhile, the seating mesh 122 type heating part 120 is provided with the clogged portions and the through hole portions by arranging a seating mesh 122 at a height lower than the upper end of the base part 110.

The seating mesh 122 is formed in a mesh form by crossing multiple metal rods or metal wires, and is configured such that the end portions thereof are fixed to the inner circumferential surface of the central portion of the base part 110.

The height of the upper end of the seating mesh 122 is formed to be lower than the top surface of the base part 110 in a range in which the metal balls 130 are capable of being stably seated on the seating bars 121.

The voids in the seating mesh 122 are arranged at an interval that is shorter than the diameter of the metal balls 130.

Since the seating mesh 122 has a configuration provided to allow the spherical metal balls 130, which will be described later, to be seated in the voids of the network structure, the inter-void distance in the seating mesh 122 is determined to be shorter than the diameter of the metal balls 130. However, in consideration of the thickness of the seating mesh 122, the inter-void distance is preferably determined at a level at which the metal balls 130 are maintained as close as possible without interfering with each other in the state in which the metal balls 130 are seated on the seating mesh 122.

The perforated seating plate 123 type heating part 120 is provided with clogged portions and through hole portions by arranging a perforated seating plate 123 at a height lower than the upper end of the base part 110.

The perforated seating plate 123 is provided in the form of a plate material in which through-hole portions are formed by arranging multiple perforations at a predetermined interval, and is configured such that the outer ends thereof are fixed to the inner circumferential surface of the central portion of the base part 110.

The size of the through hole portions in the perforated seating plate 123 is determined to be smaller than the diameter of the metal balls 130, and the interval between the multiple through hole portions is preferably determined at a level at which the metal balls 130 are maintained as close as possible without interfering with each other in the state in which the metal balls 130 are seated on the perforated seating plate 123.

Multiple metal balls 130 are arranged and seated between the clogged portions and the through hole portions on the heating part 120 so that food is placed and grilled thereon.

The metal balls 130 are provided to be seated on the seating bar 121 type heating part 120, the seating mesh 122 type heating part 120, or the perforated seating plate 123 type heating part 120, and are made of stainless steel, copper, or cast iron in a spherical shape having a diameter of 20 to 50 mm.

The metal balls 130 are configured to come into direct contact with food so as to grill the food, are made of stainless steel, such as SUS 304, copper material, or cast iron that is moisture-resistant so as not to rust and is hygienic, and have a complete spherical shape.

The size of the metal balls 130 is determined in connection with the configuration of the heating part 120. When the diameter of the metal balls 130 is less than 20 mm, the weight of the metal balls 130 is light. Thus, when the metal balls 130 are attached to the food, the metal balls 130 may be separated from the heating part 120 together with the food. Further, since the heat transferred from the heat source acts excessively, the food may be easily burned.

In addition, when the diameter of the metal balls 130 exceeds 50 mm, the conductivity from the heat source is significantly lowered, whereby thermal efficiency is lowered and food is not cooked well.

Now, the use state of a metal roasting grill, which is configured as described above, and to which the technique of the present disclosure is applied, will be schematically described below. The following description is given by way of an example with reference to embodiments of the present disclosure. Thus, it is obvious that the present disclosure is not limited by the embodiments described below and various modifications can be provided within the scope of the present disclosure.

A roasting grill according to the present disclosure is provided with a heating part 120 in the central portion of the frame-shaped base part 110, and metal balls 130 are seated on the heating part 120 so that food can be grilled thereby.

Clogged portions and through hole portions are arranged in the heating part 120, and the heating part 120 is classified into a seating bar 121 type, a seating mesh 122 type, or a perforated seating plate 123 type depending on the structure thereof.

In the seating bar 121 type heating part 120, multiple metal balls 130 are arranged to sufficiently fill the heating part 120 by seating the multiple metal balls 130 in the through hole portions between the multiple seating bars 121.

In the seating mesh 122 type heating part 120, multiple metal balls 130 are arranged to sufficiently fill the heating part 120 by seating the multiple metal balls 130 in the through hole portions formed in the voids in the seating mesh 122.

In the perforated seating plate 123 type heating part 120, the metal balls 130 are arranged to sufficiently fill the heating part 120 by seating the multiple metal balls 130 in multiple through hole portions formed at a predetermined interval in the perforated seating plate 123.

The metal balls 130 arranged on the heating part 120 may be prevented from being separated to the outside by the base part 110.

The handles 111 provided on the base part 110 are held and the base part 110 is installed on a table such that the heating part 120 is located on the upper side of the brazier accommodating a heat source such as charcoal fire.

The metal balls 130 seated on the heating unit 120 are heated to a high temperature, and food, such as meat, is placed on the metal balls and grilled.

The portions of the meat that are in contact with the metal balls 130 are turned into a brown color due to the Maillard reaction, and grilling unique to the metal balls 130 is performed. Smell and radiant heat from the charcoal fire located underside are transferred, through the through hole portions, to the portions of the meat that are not in direct contact with the metal balls, thereby adding flavor to the meat.

When food is inevitably attached to or burned on the surface that is in contact with the metal balls 130 in the process of grilling, it is necessary to replace the roasting grill. Then, by rolling the metal balls 130 in the state of wearing a predetermined oven glove that blocks heat, the orientations of the iron balls 130 are changed such that clean surface portions thereof face upwards so as to come into contact with the food, and the clean side is positioned toward the upper side in contact with the food, and then the grilling continues.

As described above, since it is possible to use the clean surface portions of the metal balls 130 by rolling the metal balls 130 in any direction whenever necessary, it is possible to eliminate the cumbersome work of replacing roasting grills in the middle of a meal as in the prior art.

When cleaning the roasting grill after completing a meal, it is possible to remove foreign substances by separately collecting the multiple metal balls 130 and causing the metal balls 130 to be rubbed with each other by simply rolling the metal balls 130 with detergent.

As described above, according to the present disclosure, a roasting grill including metal balls 130 mounted on a heating part 120 formed in the central portion of the base part 110 is provided. Thus, once the roasting grill is set, it is possible to continuously grill food using unused surface portions of the metal balls 130 by rolling the metal balls 130 in any direction, without frequent replacement.

Therefore, according to the present disclosure, it is possible to minimize the consumption of time, cost, and manpower due to frequent replacement of roasting grills when using conventional roasting grills, and to facilitate cleaning. Thus, it is possible to use roasting grills more economically and efficiently.

What is claimed is:

1. A roasting grill configured to be installed on an upper portion of a brazier accommodating a heat source to cook food for grilling, the roasting grill comprising:
a base part 110 provided in a circular or polygonal frame shape having a predetermined height and configured to be seated on a table;
a heating part 120 having clogged portions and through hole portions, which are alternately provided at predetermined intervals in the central portion of the base part 110, the heating part 120 being configured such that multiple metal balls 130 are seated thereon so as to heat food placed thereon; and
the multiple metal balls 130 arranged and seated between the clogged portions and through hole portions on the heating part 120 so that the food is placed and grilled thereon,
wherein the metal balls 130 are made of stainless steel, copper, or cast iron and are configured in a spherical shape having a diameter of 20 to 50 mm.

2. The roasting grill of claim 1, wherein the heating part 120 comprises clogged portions provided by arranging multiple seating bars 121 parallel to each other at a height lower than an upper end of the base part 110,
the interval between the through hole portions between the multiple seating bars 121 is shorter than a diameter of the metal balls 130, and
each of the seating bars 121 has a round top surface and is configured to make the metal balls 130 rollable.

3. The roasting grill of claim 1, wherein the heating part 120 is provided with clogged portions and through hole portions by arranging a seating mesh 122 or a perforated seating plate 123 at a height lower than an upper end of the base part 110, and
the through hole portions in the seating mesh 122 or the perforated seating plate 123 has a size smaller than the diameter of the metal balls 130.
